(19) United States
(12) Patent Application Publication
(10) Pub. No.: US 2010/0191899 A1
(43) Pub. Date: Jul. 29, 2010

(54) Information Processing Apparatus and Data Storage Apparatus

(76) Inventors: Takehiko Kurashige, Ome-shi (JP); Shinji Saito, Yokohama-shi (JP); Yukihiro Suda, Tachikawa-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/627,805

(22) Filed: Nov. 30, 2009

(30) Foreign Application Priority Data
Jan. 28, 2009 (JP) 2009-016961

(51) Int. Cl. G06F 12/00; G06F 12/16

(52) U.S. Cl. 711/103; 711/162; 711/112; 711/E12.001; 711/E12.008

(57) ABSTRACT

According to one embodiment, an information processing apparatus includes an storage apparatus including a first storage and a second storage. The storage apparatus includes a first data management module which stores data which is required to be read in a the predetermined period in the second storage so that the data requested to be read in the predetermined period is distinguishable. The storage apparatus further includes a second data management module which performs replacement of the data in the second storage so that data should be stored in the second storage, in an order reverse to that in which the data is requested to be read, while retaining the data stored in the second storage by the first data management module.

### CROSS-REFERENCE TO RELATED APPLICATIONS

This application is based upon and claims the benefit of priority from Japanese Patent Application No. 2009-016961, filed Jan. 28, 2009, the entire contents of which are incorporated herein by reference.

### BACKGROUND

1. Field

One embodiment of the invention relates to a data management technique which is suitably applied to a personal computer, etc., mounting, as a start-up disk, a hybrid hard disk drive (HDD) including, for example, a built-in nonvolatile semiconductor memory.

2. Description of the Related Art

In recent years, various kinds of personal computers such as notebook types and desktop types have become widely used. For these kinds of personal computers, HDDs are generally mounted as external storage devices to be used as start-up disks.

Recently, to improve the response performance of HDDs, various proposals of the so-called hybrid HDD which integrate a nonvolatile memory in the HDD and utilize the nonvolatile semiconductor memory as a cache have been developed (e.g., Jpn. Pat. Appln. KOKAI Publication No. 2003-167781).

Usually, when data access to a first storage medium is performed while utilizing a second storage medium as a cache, due to the high likelihood that the most recently accessed data will be accessed again, replacement control of data in the second storage medium is performed so that the data preferentially exists in order of positions temporally close to times in which the data has been accessed. Thereby, when a personal computer with a hybrid HDD mounted thereon is powered-up, the nonvolatile semiconductor cache memory contains the data that was accessed immediately prior to the previous power-down.

Meanwhile, it has been strongly desired to minimize the time from the point of powering-up a personal computer to the state in which it can be actually used. Therefore, when a hybrid HDD is mounted as the startup disk, a scheme, in which a conventional technique (by which the semiconductor cache memory contains the data that was accessed immediately prior to the previous power-down) is not applied as it is, but data with a high possibility of being accessed upon power-up is preferentially stored in the nonvolatile semiconductor memory, has been desired.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view showing a system configuration of an information processing apparatus (a personal computer) according to an embodiment of the invention;

FIG. 2 is an exemplary schematic view for explaining a configuration and an operation principal of a hybrid HDD provided for a computer of the embodiment;

FIG. 3 is an exemplary view for explaining a basic principle of replacement of data in a nonvolatile semiconductor memory to be executed by a control module of the hybrid HD mounted on the computer of the embodiment; and

FIG. 4 is an exemplary flowchart showing an operation procedure of the hybrid HDD upon powering-on or rebooting the computer of the embodiment.

### DETAILED DESCRIPTION

Various embodiments according to the invention will be described hereinafter with reference to the accompanying drawings. In general, according to one embodiment of the invention, an information processing apparatus includes an storage apparatus including a first storage and a second storage. The storage apparatus includes a first data management module which stores data which is required to be read in a the predetermined period in the second storage so that the data requested to be read in the predetermined period is distinguishable. The storage apparatus further includes a second data management module which performs replacement of the data in the second storage so that data should be stored in the second storage, in an order reverse to that in which the data is requested to be read, while retaining the data stored in the second storage by the first data management module.

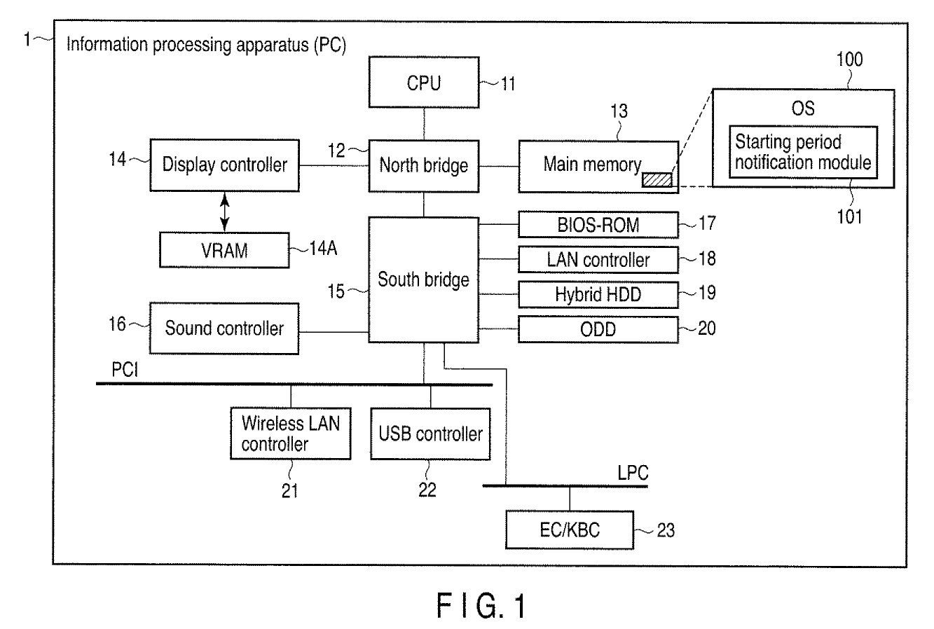

FIG. 1 is an exemplary view showing a system configuration of an information processing apparatus 1 according to an embodiment of the invention. The information processing apparatus 1 is realized as a personal computer (PC).

As shown in FIG. 1, the computer 1 includes a CPU 11, a north bridge 12, a main memory 13, a display controller 14, a video memory (VRAM) 14A, a south bridge 15, a sound controller 16, a basic input/output system (BIOS)-ROM 17, a LAN controller 18, a hybrid HDD 19, an optical disc drive (ODD) 20, a wireless LAN controller 21, a USB controller 22, an embedded controller/keyboard controller (EC/KBC) 23, etc.

The CPU 11 is a processor for controlling an operation of the computer 1, and executes operation system (OS) 100 and various application programs operating under the OS 100, which is loaded on the main memory 13 from the hybrid HDD 19 and the ODD 20. The OS 100 of the computer 1 includes a below mentioned starting period notification module 101. The CPU 11 also executes a BIOS stored in the BIOS-ROM 17. The BIOS is a program for controlling the hardware.

The north bridge 12 is a bridge device connecting a local bus of the CPU 11 to the south bridge 15. The north bridge includes a built-in memory controller performing access control of the main memory 13. The north bridge 12 further includes a function of executing communication with the display controller 14.

The display controller 14 is a device controlling a display device to be used as an output device of the computer 1. The display controller 14 generates a display signal.

The south bridge 15 controls each device on a peripheral component interconnect (PCI) bus and on a low pin count (LPC) bus. The south bridge 15 includes a built-in memory controller performing access control of an integrated drive electronic (IDE) controller for controlling the hybrid HDD 19 and the ODD 20 and the BIOS-ROM 17. Further, the south bridge 15 includes a function of executing communication with the sound controller 16 and the LAN controller 18.

The sound controller 16 is a sound source device, and outputs audio data to be reproduced to a loudspeaker which is used as an output device.

The LAN controller 18 is a cable communication device executing wired communication based on, for example, Ethernet (registered trade mark) standards, and the wireless LAN controller 21 is a wireless communication device executing wireless communication based on, for example, IEEE 802.11 standards. The USB controller 22 executes communication with external equipment, for example, through a cable based on USB 2.0 standards.

The EC/KBC 23 is an 1-chip microcomputer in which an embedded controller for performing power management and a keyboard controller for controlling a keyboard and a pointing device to be used as an input device of the computer 1 are integrated. The EC/KBC 23 includes a function of performing power on/power off of the computer 1 in response to an operation by a user.

The computer 1 having the configuration given above includes the hybrid HDD 19 as a main external storage device as a start-up disk. The computer 1 utilizes a method for shortening a starting time in a case where the hybrid HDD 19 is used as the start-up disk, and this point will be described in detail hereinafter.

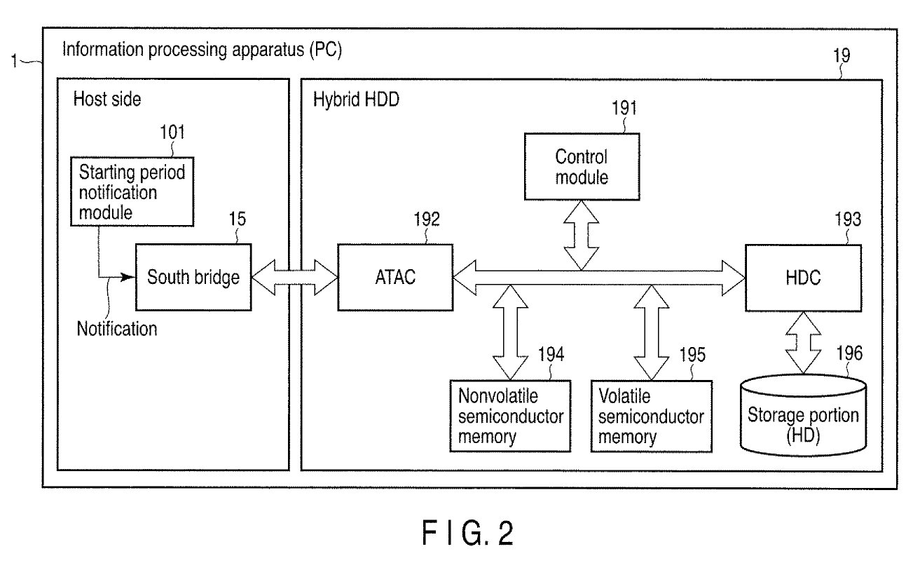

FIG. 2 is an exemplary schematic view for explaining a configuration and an operation principle of the computer 1 mounting the hybrid HDD 19 as the start-up disk.

As shown in FIG. 2, the hybrid HDD 19 includes a control module 191, an AT attachment controller (ATAC) 192, a hard disk controller (HDC) 193, a nonvolatile semiconductor memory 194, a volatile semiconductor memory 195, a storage portion 196, etc. Meanwhile, on a host side, a starting period notification module 101 of the OS 100 operates. The notification module 101 is a program for noticing a start completion to a hybrid HDD 19 side (control module 191) when the computer 1 is powered on or rebooted. When the computer 1 is rebooted, to make the hybrid HDD 19 side recognize the start of the reboot, the notification module 101 also executes a notification of a completion of shutdown of the computer 1. As a substitute for the notification of the completion of the shutdown by the notification module 101, the starting may be recognized by the hybrid HDD 19 side through the notification of the starting period from the BIOS. In terms of the time of power-on, the hybrid HDD 19 side may recognize the start time of the starting in the start of power-on.

The control module 191 is a microprocessor controlling an operation in the hybrid HDD 19. The ATAC 192 is a controller connecting with a host side, and in actual practice, with the south bridge 15 through an ATAC interface. The HDC 193 is a controller for performing drive control of the storage portion 196.

The nonvolatile semiconductor 194 is, for example, a NAND flash memory, the volatile semiconductor memory 195 is, for example, a DRAM, and the storage portion 196 is a storage unit of the hybrid HDD 19 composed of a magnetic disk (HD), a magnetic head, etc. A physical address space of the hybrid HDD 19 recognized as a logical address space on a host side is entirely assigned on the storage portion 196. The volatile semiconductor memory 195 is used for temporarily storing the data to be written in the storage portion 196 and the data read from the storage portion 196.

The nonvolatile semiconductor memory 194 is used for storing a predetermined amount of data read from the storage portion 196 in descending order of reading. For instance, since the nonvolatile semiconductor memory 194, which is a NAND flash memory, reads data at a speed faster than the storage portion 196 composed of a magnetic disk, magnetic head, etc., if the fact, in which there is a strong probability that the data which has been read more lately is read again, is taken into consideration, when power is turned on again after the power is turned off, the data read right before the turning off of the power can be read again at high speed, then, the response performance of the hybrid HDD 19 can be improved.

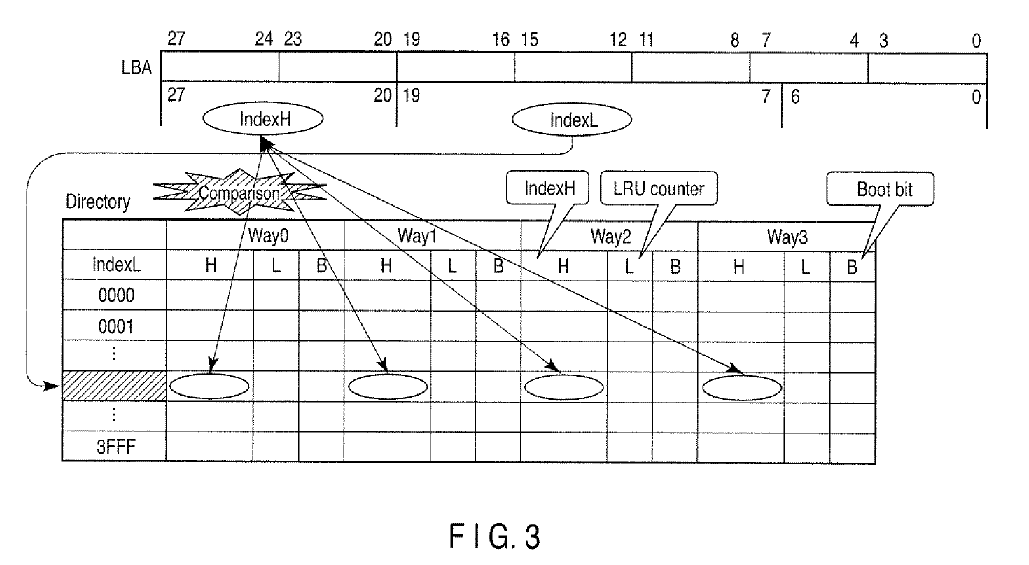

FIG. 3 is an exemplary view for explaining a basic principle of the replacement of data in the nonvolatile semiconductor 194 to be executed by the control module 191.

It is assumed that the storage capacity of the storage portion 196 is 120 G bytes, the storage capacity of the nonvolatile semiconductor memory 194 is 2 G bytes, and the line size, which is the unit by which data is stored after being read from the storage portion 196 in the nonvolatile semiconductor memory 194, is 64 K bytes. It is assumed that a 4-way-set associative system, which is a caching technique, is adopted.

A logical block address (LBA) to be specified in issuing I/O requests (a read command, a write command) from a host side, has a size of 28 bits for representing the storage capacity of 120 G bytes of the storage portion 196. A lower order 7 (0-6) bits of the LBA is determined by the line size of 64 K bytes. That is, by expressions: 64 K bytes=16 bits, and 1 sector=512 bytes=9 bits, an expression 16−9=7 is satisfied.

Middle order 13 (7-19) bits of the LBA are referred to as index L parts, and they become indices for referring to a directory managing the data stored in the nonvolatile semiconductor memory 194. The directory is placed on the memory to be managed by the control module 191, and appropriately stored in the nonvolatile semiconductor memory 196. The 13 bits of the Index L are decided by the storage capacity of 2 G bytes, the line size of 64 K bytes and the number of Ways 4 of the nonvolatile semiconductor memory 196. That is, by the storage capacity 2 G bytes=31 bits, the line size 64 K bytes=16 bits, and the number of Ways 4=2, an expression of 31−16−2=13 is satisfied.

The higher order 8 (20-27) bits of the LBA are referred to as an Index H part, and the bits are compared with a value of the Index H to be managed by the directory. The directory forms a data structure in an expression form consisting of (the number of rows of Index L)×(the number of columns of the number of set associative Ways). In this example, the directory becomes a table of 8,192 rows×4 columns.

In each row of the directory, an Index H field (H) and a least recently used (LRU) counter field (L) are disposed. Boot bit field (B) is described later. As an initial value, a value which cannot be set to the index H part, for example, a high value (“FFFF”) is set to the Index H field, and a value “0” is set to the LRU counter field.

If a read command is issued from a host side, the control module 191 determines whether or not data to be read exists in the nonvolatile semiconductor memory 194 on the hybrid HDD 19 side, by referring to the directory for each line using the Index L part of the specified LBA as a retrieval key, and by comparing whether or not the Index H agreeing with the Index H part of the LBA is held in each corresponding-row. If data exists, speed-up is achieved and response performance is improved by reading the data from the nonvolatile semiconductor memory 194 instead of by reading from the storage portion 196.

When the data is read from the nonvolatile semiconductor memory 194, the control module 191 updates the values in the LRU counter fields of the rows (Ways) corresponding to the data to a maximum value. The values in the LRU counter fields are set to the values from “0” to the number of Ways (here, 0 to 4), the control module 191 updates the values of the LRU counters to “4”. At this moment, if any LRU counter field of another row having a value larger than the value before update exists, the control module 191 updates this value by decrementing it by one.

According to this operation, the LRU counter fields have values 4→3→2→1 in order of positions temporally close to times in which the reading has been required, or have a value “0”, which is the initial value.

If data to be read does not exist in the nonvolatile semiconductor memory 194, the control module 191 executes reading of the data from the storage portion 196. At this moment, the control module 191 stores the read data in the nonvolatile semiconductor 194. At this time, if other data, of which the Index L parts of the LBAs agreeing with one another are stored by the number of Ways, namely by “4”, has been stored already, the control module 191 ejects data of which the value in the LRU counter field is a minimum value “1”, and stores other data instead of the data of value “1”. At this moment, the control module 191 sets the value in the LRU counter field of the stored data to a maximum value, and updates the values in other LRU counter fields by decrementing them by one. If the number of pieces of data stored does not reach “4”, the control module 191 stores this data in empty Ways, and sets the value of the data in the LRU counter fields. If other stored data exists, the control module 191 decrement all the values in other LRU counter fields by one, respectively.

In this way, providing a scheme to execute the reading from the nonvolatile semiconductor memory 194 as a substitute for the reading from the storage portion 196 of which the reading speed is slower than that of the nonvolatile semiconductor memory 194 improves the response performance of the hybrid HOD 19.

Since the nonvolatile semiconductor memory 194 composed of NAND flash memories is a write-once storage medium, the data update is executed by invalidating data before update and by newly writing data after update. Thereby, for example, if the nonvolatile semiconductor memory 194 is composed of a single NAND flash memory, the invalidation of the data before update and the writing of the data after update are serially executed. Thereby in writing aimed at updating the data, there is the possibility that the nonvolatile semiconductor memory 194 takes more time than the storage portion 196. In such a case, when a write command is issued from the host side, the control module 191 executes the writing in the storage portion 196, and if any data to be updated exists in the nonvolatile semiconductor memory 194 with this writing, also executes to invalidate the data.

Meanwhile, for example, in a case in which the nonvolatile semiconductor memory 194 is composed of a plurality of NAND flash memories, and in which the invalidation of the data before update and the writing of the data after update can be executed in parallel, that is, in a case in which the data update can be executed at a speed faster than that of the storage portion 196, the control module 191 executes access to the nonvolatile semiconductor memory 194.

The hybrid HOD 19 not only utilize the nonvolatile semiconductor memory 194 as the cache of the storage 196 based on the probability that the data which has been read most recently will be read again, but is also further provided with a scheme to utilize the nonvolatile semiconductor memory 194 for shortening the starting time of the computer 1. Next, the scheme will be described.

To shorten the starting time of the computer 1, a Boot bit field is further provided for each column of the directory as shown in FIG. 3. The control module 191 secures trace buffers on memories which are managed by the control module 191 itself.

(1) In a case of start of power-on, (2) in a case of reception of a shutdown completion notification from the notification module 101 on the host side, or (3) in a case of reception of a starting notification from the BIOS on the host side, the control module 191 starts processing for recording LBAs of data of which the reading is required from the host side in the trace buffers. The control module 191 continues this recording in the trace buffers at these LBAs until the reception of a notification of start completion from the notification module 101 on the host side. Before the reception of the start completion notification, even when the trace buffer is full, the control module 191 completes the recording in the trace buffer of the LBA.

After recording the LBAs in the trace buffers, the control module 191 executes the next processing by using an idle state of the hybrid HDD 19, namely, gap time in which no processing accompanied by the I/O request from the host side is performed.

The control module 191 firstly sets all Boot bit fields in the directory to “0” (off). Since there is a high possibility that the processing to be executed under the foregoing condition is performed intermittently, the control module 191 manages information showing up to which of the Boot bit fields the processing has been progressed.

After setting all the Boot bit fields in the directory to “0”, the control module 191 sequentially reads the LBAs recorded in the trace buffers, checks whether or not the data corresponding to the read LBAs exists in the nonvolatile semiconductor memory 194, namely, whether or not the data is registered in the directory, and if the data is registered, sets the Boot bit fields to “1” (on). Conversely, if the data is not registered in the directory, since the data has been ejected by data of which the reading is required after start completion, the control module 191 ejects the data of which the value in the LRU counter field is set to minimum in the setting of the Boot bit field to “0”, and registers the data as a substitute for the ejected data. At this moment, the Boot bit field is set to “1”, and also the value of the LRU counter field is set to maximum, the values of other LUR counter fields are updated by decrementing them by one.

In a case in which all the Boot bit fields of other data are set to “1” (although the probability is very low), the control module 191 does not store the corresponding-data in the nonvolatile semiconductor memory 194. Since this processing is also executed under the aforementioned condition, there is a high possibility that such processing will proceed intermittently. Therefore, the control module 191 manages the information showing up to which of the LBAs recorded in the trace buffers the processing has been progressed.

After the clearing of the foregoing Boot bit field to “0” and after the storage of the LBA data recording in the trace buffer in the nonvolatile semiconductor memory 194, while the processing in the hybrid HDD 19 shifts to ordinary processing, when storing the data of which the reading is required in the nonvolatile semiconductor memory 194, namely, when registering the data in the directory, the control module 191 ejects the data of the Boot bit field which has been set to “1” from the object to be ejected in selection of the data to be ejected. Thereby, since the data read in the starting period has been stored in the nonvolatile memory, the starting time of the computer 1 with the hybrid HDD 19 mounted thereon is shortened.

The clearing of the Boot file, the storage of the data of which the reading has been performed in the starting period in the nonvolatile semiconductor memory 194, and turning-on of the Boot field of the concerned data are performed by the hybrid HDD 19 side. Therefore, even if the operation environment of the computer 1 is changed, for example, even if the OS 100 of the computer 1 is updated, since the data read in the starting period under the operation environment after the change is stored in the nonvolatile semiconductor 194 in staring at a first time, the starting time of the computer 1 after the change in operation environment may be shortened after starting at a second time.

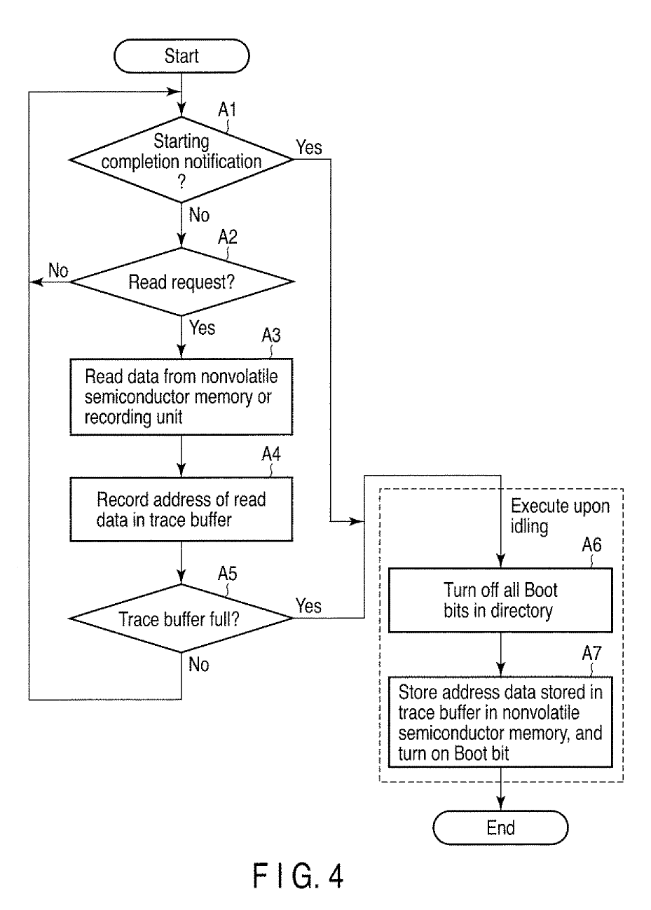

FIG. 4 is an exemplary flowchart showing an operation procedure of the hybrid HDD 19 upon powering-on or rebooting the computer 1.

When the computer 1 is activated with the powering-on or the rebooting, the control module 191 of the hybrid HDD 19 monitors the starting completion notification from the host side (Block A1), and if the starting completion notification is not transmitted (NO in Block A1), the control module 191 further monitors the data reading request from the host side (Block A2).

With respect to the data reading request before starting completion notification, the control module 191 reads the relevant data from the nonvolatile semiconductor memory 194 or the storage portion 196 (Block A3), and records the LBA of the data in the trace buffer (Block A4). When storing the LBA, the control module 191 checks whether or not the trace buffer is full (Block A5), and if the trace buffer is not full (NO in block A5), the control module 191 repeats the processing from Blocks A1 to A5.

Conversely, if the starting completion notification is transmitted (YES in Block A1), or if the trace buffer is full (YES in Block A5), the control module 191 utilizes a period in which no processing corresponding to the request from the host side is executed, to firstly turn off all the Boot bit fields in the directory for managing the data stored in the nonvolatile semiconductor memory 194 (Block A6). Next, the control module 191 stores the LBA data recorded in the trace buffer in the nonvolatile semiconductor memory 194, and the control module 191 executes processing to turn on the Boot bit field in the directory corresponding to the data (Block A7).

As mentioned above, according to the computer 1, the starting time can be shortened in the case where the hybrid HDD 19 including the built-in nonvolatile semiconductor memory 194 as the cache of the storage portion 196 (composed of HD, etc.) is mounted as the starting disk.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a storage apparatus; and
a main body apparatus configured to perform data writing in the storage apparatus and data reading from the storage apparatus, wherein:
the main body apparatus comprises a notification module configured to transmit a notification relevant to a starting period comprising at least a starting completion point to the storage apparatus, when performing a starting processing in response to a power-on instruction or a restart instruction;
the storage apparatus comprises:
a nonvolatile first storage;
a nonvolatile second storage; and
a read control module configured (i) to read data from the second storage and to transmit the read data to the main body apparatus when the main body apparatus requests to perform data reading and the data to be read is stored in the second storage, and (ii) to read data from the first storage, to transmit the read data to the main body apparatus and to store the read data in the second storage when the main body apparatus requests to perform data reading and the data to be read is not stored in the second storage,
the read control module comprising:
a first data management module configured to store data requested to be read in a time period by the main body apparatus in the second storage so that the data requested to be read in the starting period of the main body apparatus is distinguishable, the time period being a time period from a time when the storage apparatus starts an operation along with starting processing of the main body apparatus until a time when the notification is transmitted from the main body apparatus, and
a second data management module configured to perform replacement of the data in the second storage so that data should be stored in the second storage, in an order reverse to that in which the data has been requested to be read, while retaining the data stored in the second storage by the first data management module.

2. The information processing apparatus of claim 1, wherein the storage apparatus further comprises a write control module configured (i) to store data to be written in the first storage when the main body apparatus requests to perform data writing, and (ii) to invalidate data to be updated in the second storage when the main body apparatus requests to perform data writing and the data to be updated along with this writing is stored in the second storage.

3. The information processing apparatus of claim 1, wherein the first data management module is configured to invalidate attribute information added to data stored in the second storage by the first data management module every time the storage device starts an operation along with the starting processing of the main body apparatus, the attribute information distinguishing the data requested to be read in the starting period of the main body apparatus.

4. The information processing apparatus of claim 1, wherein the second storage has a storage capacity smaller than a storage capacity of the first storage.

5. The information processing apparatus of claim 4, wherein the first storage comprises a magnetic disk, and the second storage comprises a nonvolatile semiconductor memory.

6. A data storage apparatus comprising:
a nonvolatile first storage;
a nonvolatile second storage;
a read control module configured (i) to read data from the second storage and to transmit the read data to a source of request when the source of request requests to perform data reading and the data to be read is stored in the second storage, and (ii) to read the data from the first storage, to transmit the read data to the source of request and to store the read data in the second storage when the source of request requests to perform data reading and the data to be read is not stored in the second storage,
the read control module comprising:
a first data management module configured to store data requested to be read in a time period in the second storage so that the data requested to be read in a predetermined period is distinguishable, the time period being a time period from a time when the data storage apparatus starts an operation until a time when a predetermined notification is transmitted, and
a second data management module configured to perform replacement of the data in the second storage so that data should be stored in the second storage, in an order reverse to that in which the data has been requested to be read, while retaining the data stored in the second storage by the first data management module.

7. The data storage apparatus of claim 6, further comprising a write control module configured (i) to store data to be written in the first storage when data writing is required, and (ii) to invalidate data to be updated in the second storage when data writing is required and the data to be updated along with this writing is stored in the second storage.

8. The data storage apparatus of claim 6, wherein the first data management module is configured to invalidate attribute information added to data stored in the second storage by the first data management module every time the data storage apparatus starts an operation, the attribute information distinguishing the data requested to be read in a predetermined period.

9. The data storage apparatus of claim 6, wherein the second storage has a storage capacity smaller than a storage capacity of the first storage.

10. The data storage apparatus of claim 6, wherein the first storage comprises a magnetic disk, and the second storage comprises a nonvolatile semiconductor memory.
